(19) United States
(12) Patent Application Publication
(10) Pub. No.: US 2012/0226929 A1
(43) Pub. Date: Sep. 6, 2012

(54) Integrated Circuit Devices Including Detection For Multiple Power Supply Voltages And Related Systems And Methods

(76) Inventor: Seung Ho Lee, Seoul (KR)

(21) Appl. No.: 13/310,031

(22) Filed: Dec. 2, 2011

(30) Foreign Application Priority Data
Mar. 3, 2011 (KR) 10-2011-0019011

(51) Int. Cl. G06F 11/30

(52) U.S. Cl. 713/340

(57) ABSTRACT

A System on Chip (SoC) may include a logic circuit, a plurality of input/output pads, and a plurality of input/output circuits electrically coupled between the logic circuit and respective ones of the plurality of input/output pads. In addition, a voltage detection circuit may be coupled to the plurality of input/output circuits. More particularly, the voltage detection circuit may be configured to detect first and second power supply voltages at the plurality of input/output circuits with the first and second power supply voltages having different on-state voltage levels. Related methods are also discussed.

### CROSS-REFERENCE TO RELATED APPLICATION

This application claims the benefit of priority under 35 U.S.C. §119(a) from Korean Patent Application No. 10-2011-0019011 filed on Mar. 3, 2011, the disclosure of which is hereby incorporated by reference in its entirety.

### BACKGROUND

Embodiments of present inventive concepts relate to integrated circuit devices, and more particularly, to integrated circuit devices including power supply detection and related systems and methods.

Recently, as complexities of system on chip (SoC) technologies have increased, communication between a plurality of functional elements integrated in an SoC chip and/or communication between a plurality of SoC chips over a system bus has increased.

Differences may occur in specifications of input/output circuits embodied in each of a plurality of chips communicating with each other. Therefore, in a configuration of a SoC system, an input/output interface scheme reducing influence between the plurality of chips may increase in importance.

### SUMMARY

Present inventive concepts may provide semiconductor integrated circuit devices detecting a level of a voltage supplied to a core logic during a power off state, a power up operation or a power down operation and controlling a state of an input/output pad embodied in an input/output block according to a detection result. Related methods of operation and/or systems including such semiconductor devices may also be provided.

According to some embodiments, a System on Chip (SoC) may include a logic circuit, a plurality of input/output pads, a plurality of input/output circuits, and a voltage detection circuit. The plurality of input/output circuits may be electrically coupled between the logic circuit and respective ones of the plurality of input/output pads, and the voltage detection circuit may be coupled to the plurality of input/output circuits. The voltage detection circuit may be configured to detect first and second power supply voltages at the plurality of input/output circuits with the first and second power supply voltages having different on-state voltage levels.

According to some other embodiments, a System on Chip (SoC) may include an internal power management circuit, a logic circuits, first and second pluralities of input/output pads, and first and second voltage detection circuits. The internal power management circuit may be configured to receive first and second power supply voltages from outside the electronic device and to control distribution of the first and second power supply voltages. The first plurality of input/output circuits may be electrically coupled between the logic circuit and respective ones of the first plurality of input/output pads. The first voltage detection circuit may be coupled to the first plurality of input/output circuits with the first voltage detection circuit being configured to detect first and second power supply voltages from the internal power management circuit at the first plurality of input/output circuits with the first and second power supply voltages having different on-state voltage levels. The first plurality of input/output circuits may be configured to be set to a first state responsive to the first voltage detection circuit detecting at least one of the first power supply voltage at a level less than a first threshold and/or the second power supply voltage at a level less than a second threshold at the first plurality of input/output circuits. The first plurality of input/output circuits may be configured to be set to a second state to allow data communication between the logic circuit and respective ones of the first plurality of input/output pads responsive to the first voltage detector detecting the first power supply voltage at a level greater than the first threshold and detecting the second power supply voltage at a level greater than the second threshold at the first plurality of input/output circuits. The second plurality of input/output circuits may be electrically coupled between the logic circuit and respective ones of the second plurality of input/output pads. The second voltage detection circuit may be coupled to the second plurality of input/output circuits with the second voltage detection circuit being configured to detect the first and second power supply voltages from the internal power management circuit at the second plurality of input/output circuits. The second plurality of input/output circuits may be configured to be set to the first state responsive to the second voltage detection circuit detecting at least one of the first power supply voltage at a level less than a first threshold and/or the second power supply voltage at a level less than a second threshold at the second plurality of input/output circuits. The second plurality of input/output circuits may be configured to be set to the second state to allow data communication between the logic circuit and respective ones of the second plurality of input/output pads responsive to the second voltage detection circuit detecting the first power supply voltage at a level greater than the first threshold and detecting the second power supply voltage at a level greater than the second threshold at the second plurality of input/output circuits.

According to still other embodiments, methods may be provided to operate an electronic device including a plurality of input/output circuits electrically coupled between a logic circuit of the electronic device and respective input/output pads. First and second power supply voltages may be detected at the plurality, of input/output circuits with the first and second power supply voltages having different on-state voltage levels. Responsive to at least one of detecting the first power supply voltage at a level less than a first threshold and/or detecting the second power supply voltage at a level less than a second threshold, the plurality of input/output circuits may be set to a first state. Responsive to detecting the first power supply voltage at a level greater than the first threshold and detecting the second power supply voltage at a level greater than the second threshold, the plurality of input/output circuits may be set to a second state to allow data communication through the plurality of input/output circuits between the logic circuit and the respective input/output pads.

According to yet other embodiments, an electronic system may include a circuit board, a power management circuit on the circuit board, and an electronic device on the circuit board. The circuit board may include a communications bus having a plurality of conductive bus lines. The power management circuit may be configured to provide first and second power supply voltages with the first and second power supply voltages having different on-state voltages. The electronic device may be configured to receive the first and second power supply voltages from the power management circuit, and the electronic device may include a logic circuit, a plurality of input/output pads, a plurality of input/output circuits, and a voltage detection circuit. The plurality of input/output pads may be electrically coupled to respective ones of the conductive bus lines, and the plurality of input/output circuits may be electrically coupled between the logic circuit and respective ones of the input/output pads. The voltage detection circuit may be coupled to the plurality of input/output circuits, with the voltage detection circuit being configured to detect the first and second different power supply voltages at the plurality of input/output circuits.

According to further embodiments, a System on Chip may include a logic circuit, a plurality of input/output circuits, and a voltage detection circuit. The plurality of input/output circuits may be electrically coupled between the logic circuit and a respective plurality of input/output pads, and the voltage detection circuit may be coupled to the plurality of input/output circuits with the voltage detection circuit being configured to detect first and second power supply voltages having different on-state voltage levels. The plurality of input/output circuits may be configured to be set to a high impedance state responsive to the voltage detection circuit detecting at least one of the first power supply voltage at a level less than a first threshold and/or the second power supply voltage at a level less than a second threshold. The plurality of input/output circuits may be configured to allow data communication between the logic circuit and the respective input/output pads responsive to the voltage detector detecting the first power supply voltage at a level greater than the first threshold and detecting the second power supply voltage at a level greater than the second threshold.

According to still further embodiments, an electronic device may include a logic circuit, a plurality of input/output pads, a plurality input/output circuits, and a voltage detection circuit. The plurality of input/output circuits may be electrically coupled between the logic circuit and respective ones of the plurality of input/output pads. The voltage detection circuit may be coupled to the plurality of input/output circuits with the voltage detection circuit being configured to detect first and second power supply voltages at the plurality of input/output circuits with the first and second power supply voltages having different on-state voltage levels. The plurality of input/output circuits may be configured to be set to a first state responsive to the voltage detection circuit detecting at least one of the first power supply voltage at a level less than a first threshold and/or the second power supply voltage at a level less than a second threshold, and/or an external reset signal. The plurality of input/output circuits may be further configured to allow data communication between the logic circuit and the respective input/output pads responsive to the voltage detector detecting the first power supply voltage at a level greater than the first threshold and detecting the second power supply voltage at a level greater than the second threshold and detecting an absence of the external reset signal.

According to still further embodiments, an electronic device may include a logic circuit, a plurality of input/output pads, a plurality of input/output circuits, and first and second voltage detection circuits. The plurality of input/output circuits may be electrically coupled between the logic circuit and respective ones of the plurality of input/output pads with the plurality of input output circuits being configured to operate using first and second power supply voltages with an on-state voltage level of the first power supply voltage being less than an on-state voltage of the second power supply voltage. The first voltage detection circuit may be configured to generate a first enable signal responsive to the first power supply voltage being greater than a first threshold and responsive to the second power supply voltage being greater than a second threshold, and to generate a first disable signal responsive to the first power supply voltage being less than the first threshold and/or the second power supply voltage being less than the second threshold. The second voltage detection circuit may be configured to generate a second enable signal responsive to the second power supply voltage being greater than the second threshold without considering the first power supply voltage and to generate a second disable signal responsive to the second power supply voltage being less than the second threshold without considering the first power supply voltage. The plurality of input/output circuits may be configured to be set to a first state responsive to the first voltage detection circuit generating the first disable signal and/or responsive to the second voltage detection circuit generating the second disable signal. Moreover, the plurality of input/output circuits may be configured to be set to second state to allow data communication between the logic circuit and the respective input/output pads responsive to the first voltage detection circuit generating the first enable signal and responsive to the second voltage detection circuit generating the second enable signal.

### BRIEF DESCRIPTION OF THE DRAWINGS

These and/or other aspects and advantages of present inventive concepts will become apparent and more readily appreciated from the following description of the embodiments, taken in conjunction with the accompanying drawings of which:

FIG. 1A is a block diagram of a system according to an example embodiment of present inventive concepts;

FIG. 1B is a plan view illustrating a package including a semiconductor integrated circuit SOC device illustrated in FIG. 1A;

FIG. 2A is a block diagram of a semiconductor integrated circuit device illustrated in FIG. 1A;

FIG. 2B is a schematic diagram of a package including the semiconductor integrated circuit device illustrated in FIG. 2A;

FIG. 3 is a schematic block diagram of an input/output block illustrated in FIG. 2A;

FIG. 4 is a block diagram illustrating an example embodiment of a unit input/output circuit illustrated in FIG. 3;

FIG. 5 is a block diagram illustrating another example embodiment of a unit input/output circuit illustrated in FIG. 3;

FIG. 6 is a block diagram illustrating still another example embodiment of a unit input/output circuit illustrated in FIG. 3;

FIG. 7 is a block diagram illustrating still another example embodiment of a unit input/output circuit illustrated in FIG. 3;

FIG. 8 is a block diagram illustrating an example embodiment of a voltage detection circuit illustrated in FIG. 2A;

FIG. 9 is a circuit diagram illustrating an example embodiment of a voltage detection circuit illustrated in FIG. 8;

FIG. 10 is a circuit diagram illustrating another example embodiment of a voltage detection circuit illustrated in FIG. 8;

FIG. 11A is a circuit diagram illustrating another example embodiment of a voltage detection circuit illustrated in FIG. 2A;

FIG. 11B is a circuit diagram illustrating still another example embodiment of a voltage detection circuit illustrated in FIG. 2A;

FIG. 12 is a circuit diagram illustrating an embodiment of a second voltage detection circuit illustrated in FIG. 11A or 11B;

FIG. 13A is an example embodiment of a waveform diagram of a first voltage, a second voltage and a detection signal;

FIG. 13B is another example embodiment of a waveform diagram of the first voltage, the second voltage and the detection signal;

FIG. 14 is a flowchart illustrating operations of a voltage detection circuit illustrated in FIG. 2A;

FIG. 15 is another flowchart illustrating operations of the voltage detection circuit illustrated in FIG. 2A; and

FIG. 16 is a block diagram illustrating an example embodiment example of the semiconductor system illustrated in FIG. 1A.

### DETAILED DESCRIPTION OF THE PREFERRED EMBODIMENTS

Advantages and features of present inventive concepts and methods of accomplishing the same may be understood more readily by reference to the following detailed description of embodiments and the accompanying drawings. Present inventive concepts may, however, be embodied in many different forms and should not be construed as being limited to embodiments set forth herein. Rather, these embodiments are provided so that this disclosure will be thorough and complete and will fully convey present inventive concepts to those skilled in the art, and the scope of present inventive concepts will only be defined by the appended claims. Like reference numerals refer to like elements throughout the specification.

It will be understood that when an element is referred to as being “connected to” or “coupled to” another element, it can be connected or coupled to the other element or intervening elements may be present. In contrast, when an element is referred to as being “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, etc. may be used herein to describe various elements, components, and/or sections, these elements, components, and/or sections should not be limited by these terms. These terms are only used to distinguish one element, component or section from another element, component, or section. Thus, a first element, component, or section discussed below could be termed a second element, component, or section without departing from the teachings of present inventive concepts.

Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, when terms used in this specification are not specifically defined, all the terms used in this specification (including technical and scientific terms) can be understood by those skilled in the art. Further, when general terms defined in the dictionaries are not specifically defined, the terms will have the normal meaning in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the drawings, the illustrated features may be changed due to, for example, the manufacturing technology and/or tolerance. Accordingly, it should be understood that the example embodiments of present inventive concepts are not limited to the drawings but include modifications of the features of elements caused due to, for example, the manufacture.

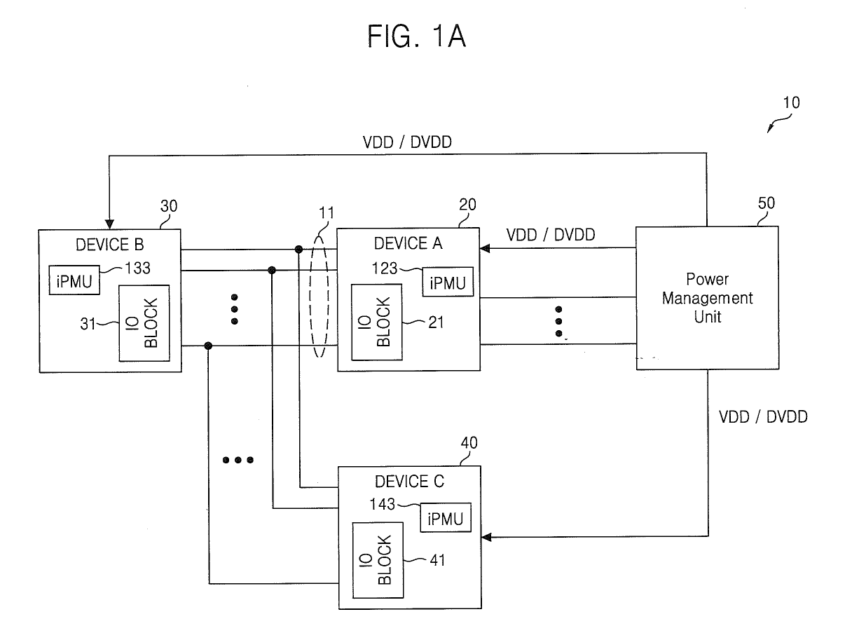

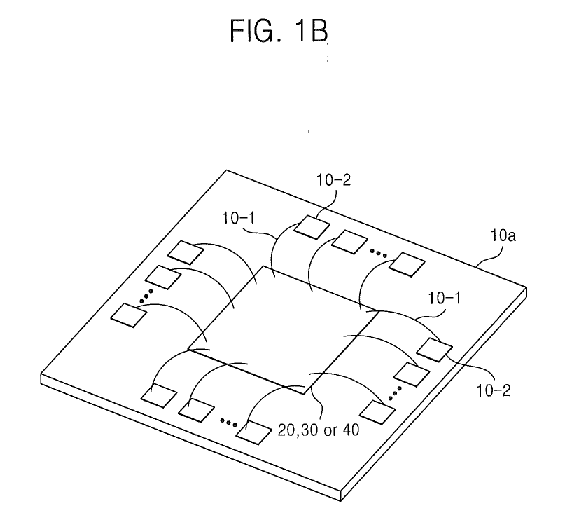

FIG. 1A is a block diagram of a semiconductor system 10 according to an example of embodiments of present inventive concepts. Referring to FIG. 1A, the semiconductor system 10 includes a plurality of semiconductor integrated circuit devices 20, 30, and 40 each sharing a bus 11 and a power management unit (PMU) 50 supplying a plurality of operation voltages, e.g., a first voltage VDD and a second voltage DVDD, to each of the plurality of semiconductor devices 20, 30, and 40. Devices 20, 30, and 40 and power management unit (PMU) 50, for example, may be mounted on a printed circuit board including bus 11.

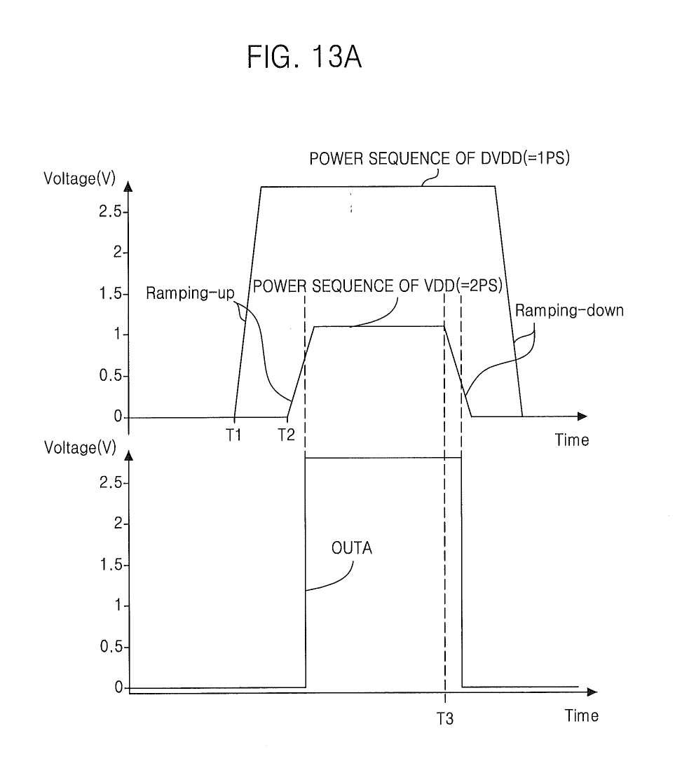

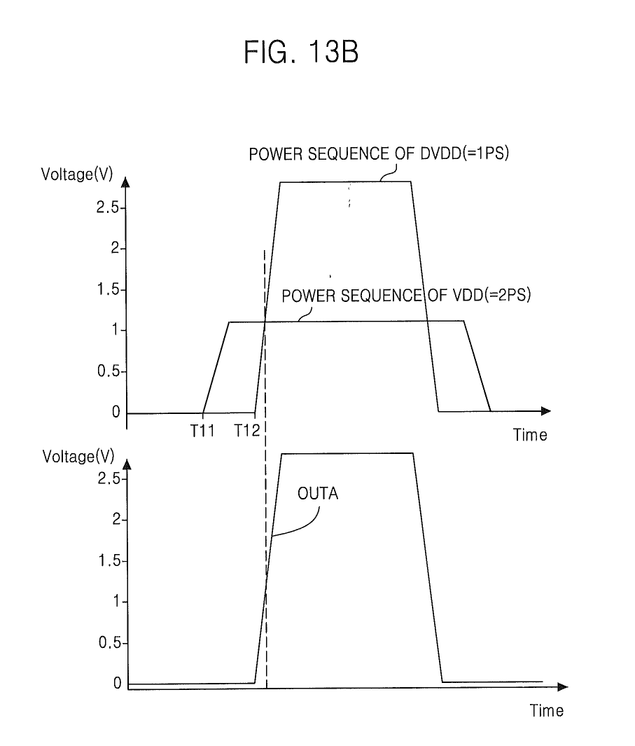

As illustrated in FIGS. 13A and 13B, the first voltage VDD may have a voltage waveform according to a first power sequence 1PS, and the second voltage DVDD may have a voltage waveform according to a second power sequence 2PS which is different from the first power sequence 1PS. That is, a ramping-up time point T2 or T11 of the first voltage VDD is different from a ramping-up time point T1 or T12 of the second voltage DVD, and a ramping down time point of the first voltage VDD is different from a ramping down time point of the second voltage DVDD.

The power management unit 50 may further supply at least a different third voltage in addition to the first voltage VDD and the second voltage DVDD to each of the plurality of semiconductor devices 20, 30, and 40.

Each of the semiconductor devices 20, 30, and 40 may be embodied as a system on chip (SoC) and/or an integrated circuit. In addition, system 10 may be embedded in a mobile communication device such as a mobile phone, a smart phone, a tablet personal computer (PC), or a personal digital assistant (PDA). According to an example of some embodiments, system 10 may be embodied in an information technology (IT) device or a portable electronic device.

Each of the semiconductor devices 20, 30, and/or 40 may communicate with each other through the bus 11 and respective input/output blocks 21, 31, or 41. Each of the semiconductor devices 20, 30, and 40 may be embodied as a unit chip. Each of the semiconductor devices 20, 30, and 40 illustrated in FIG. 1 may include each of the respective input/output blocks 21, 31, and 41 configured to perform data input and/or output operations. The semiconductor devices 20, 30, and 40 may be embodied as different semiconductor chips coupled through bus 11, or all of the semiconductor devices 20, 30, and 40 may be embodied on a same semiconductor substrate with bus 11 thereon. As discussed in greater detail below, each of the semiconductor devices 20, 30, and 40 may include a respective internal power management unit (iPMU) 123, 133, and 143 to control internal distribution of operation voltages VDD and DVDD to elements of devices 20, 30, and 40.

To reduce or minimize power consumption of the semiconductor system 10, each of the semiconductor devices 20, 30 and 40 may be independently powered on/off. Stated in other words, each of the semiconductor devices 20, 30, and 40 may individually perform power up/down operations/sequences.

Here, a power up operation/sequence means the first voltage VDD and/or the second voltage DVDD is/are ramped up to supply power to a semiconductor device that was previously powered off. A power down operation/sequence means the first voltage VDD and/or the second voltage DVDD is/are ramped down to power off a semiconductor device that was previously powered on.

The power management unit 50 may control power up and/or power down operations of each of the plurality of operation voltages including VDD and DVDD. Moreover, power management unit 50 may selectively/separately provide VDD/DVDD to each of the semiconductor devices 20, 30 and/or 40.

During power up and/or power down operations, each of the semiconductor devices 20, 30, and 40 may detect a level of at least one of the first voltage VDD and/or the second voltage DVDD and may control each state of a plurality of input/output pads embodied in each of the input/output blocks 21, 31, and 41 of each semiconductor device 20, 30, and 40 according to a detection result.

For convenience of explaining present inventive concepts, the second semiconductor device 30 among the plurality of semiconductor devices 20, 30, and 40 may be assumed to perform a power up operation and/or a power off operation. Present inventive concepts, however, may be similarly applied to semiconductor devices 20 and/or 40.

Semiconductor devices 20 and 40 (among the plurality of semiconductor devices 20, 30, and 40) may communicate through the bus 11 and/or may perform signal interfacing in a power on state. Here, a signal transmitted and received between semiconductor devices 20 and 40 may be affected by each state of a plurality of pads embodied in an input/output block 31 of the second semiconductor device 30.

Therefore, present inventive concepts may provide a scheme which may control each state of the plurality of pads embodied in the input/output block 31 of the second semiconductor device 30 to be in a requested state (e.g., a high-impedance state, a high voltage level state, or a low level voltage state), so that, even if a power up operation or a power off operation is performed on the second semiconductor device 30, the operation may not significantly affect a signal transmitted or received between the other semiconductor devices 20 and 40.

FIG. 1B is a plan view of a package including a semiconductor device 20, 30, or 40 illustrated in FIG. 1A. Referring to FIGS. 1A and 1B, the semiconductor device 20, 30, or 40 may be packaged using package 10a. The package 10a includes the semiconductor device 20, 30, or 40 embodied in a SoC style and/or an integrated circuit style, a plurality of electrical connection means (e.g., a plurality of bonding wires 10-1), and a plurality of input/output pins 10-2. Each of the input/output blocks 21, 31 and 41 of the semiconductor system 10 is connected to a plurality of input/output pins 10-2 through a plurality of bonding wires 10-1.

The package 10a may be embodied as a Package On Package (PoP), a Ball Grid Array (BGA), a Chip Scale Package (CSP), a Plastic Leaded Chip Carrier (PLCC), a Plastic Dual In-Line Package (PDIP), a Die in Waffle Pack, a Chip On Board (COB), a CERamic Dual In-Line Package (CERDIP), a Plastic Metric Quad Flat Pack (MQFP), a Thin Quad FlatPack (TQFP), a Small Outline Integrated Circuit (SOIC), a Shrink Small Outline Package (SSOP), a Thin Small Outline Package (TSOP), a System In Package (SIP), a Multi-Chip Package (MCP), a Wafer-level Fabricated Package (WFP) and/or a Wafer-level Processed Stack Package (WSP).

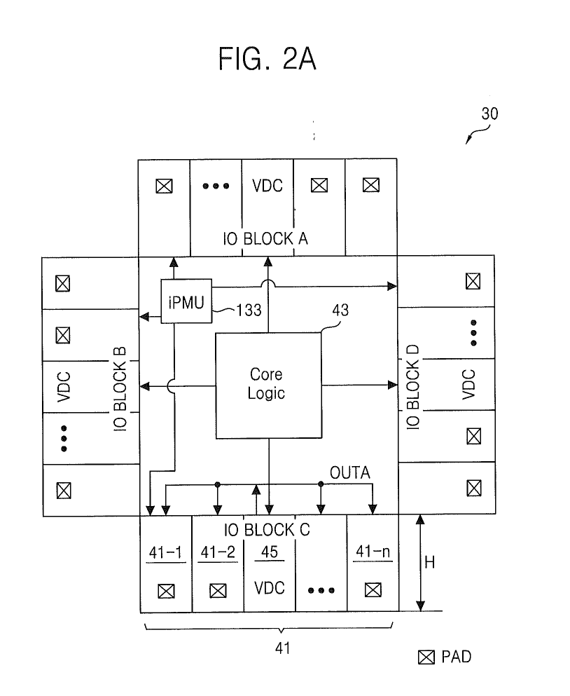

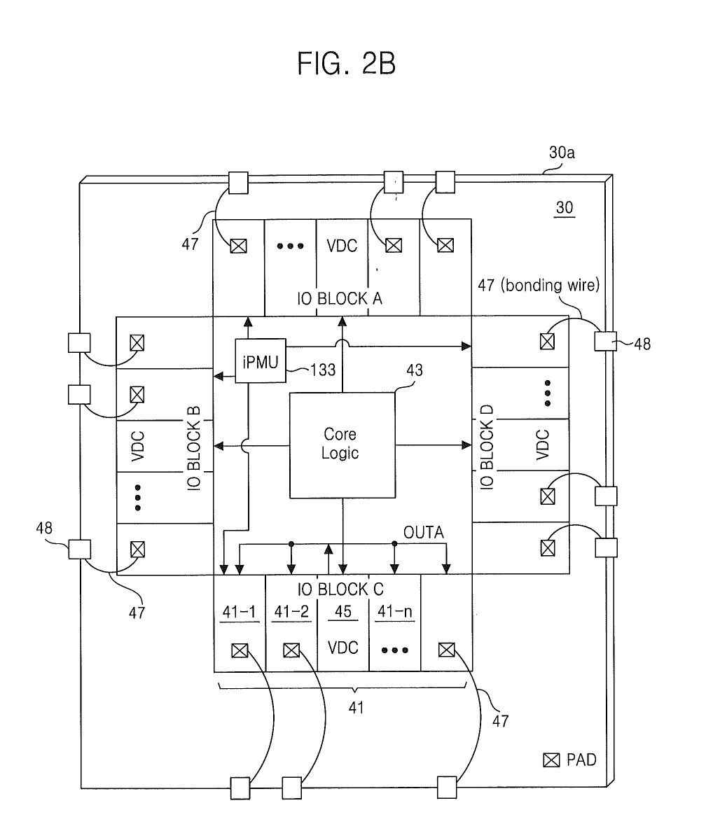

FIG. 2A is a block diagram of the semiconductor device 30 illustrated in FIG. 1A. Referring to FIGS. 1A and 2A, the semiconductor device 30 may include a logic circuit such as core logic 43 using the first voltage VDD as an operation voltage, and a plurality of input/output blocks IO BLOCK A to IO BLOCK D. Each of the plurality of input/output blocks IO BLOCK A to IO BLOCK D uses the second voltage DVDD as an operation voltage. For example, as illustrated in FIGS. 13A and 13B, a maximum level of the second voltage DVDD may be set to be higher than a maximum level of the first voltage VDD. While not required, an internal Power Management Unit (iPMU) 133 may separately control distribution of power supply voltages VDD and DVDD to IO blocks A to D. Stated in other words internal Power Management Unit 133 may separately/selectively provide VDD and DVDD to IO blocks A to D.

The core logic 43 may generate at least an input/output control signal controlling each usage of the plurality of input/output blocks IO BLOCK A to IO BLOCK D. Here, usage means that an input/output block is used as an input block transmitting data input through the bus 11 to the core logic 43 or used as an output block transmitting data output from the core logic 43 to the bus 11.

Usage of the plurality of input/output blocks IO BLOCK A to IO BLOCK D may be controlled independently. Each of the plurality of input/output blocks IO BLOCK A to IO BLOCK D may include a plurality of unit input/output circuits, e.g., 41-1 to 41-n (where n is a natural number), and a voltage detection circuit (VDC) 45. According to an example embodiment, a VDC 45 may be embodied in each edge of the plurality of input/output blocks IO BLOCK A to IO BLOCK D, between the plurality of unit input/output circuits, e.g., 41-1 to 41-n, or in a center.

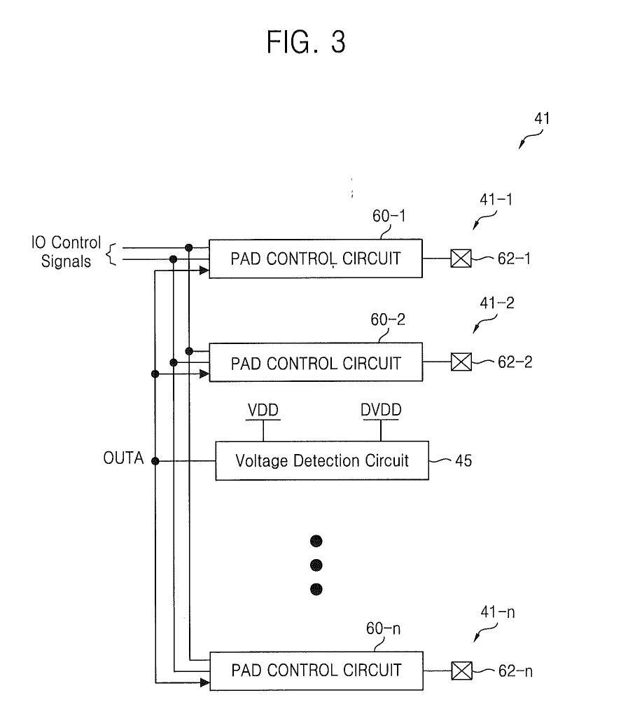

As illustrated in FIG. 3, each of the plurality of unit input/output circuits, e.g., 41-1 to 41-n, includes a pad control circuit 60-1 to 60-n and an input/output pad 62-1 to 62-n. The VDC 45 generates a detection signal OUTA used to control a state of an input/output pad embodied in each of the plurality of unit input/output circuits.

For convenience of explanation, an input/output block 41 illustrated in FIG. 2A is assumed to be an example of an input/output block 31 illustrated in FIG. 1A. Layout length H of the voltage detection circuit (VDC) 45 may be embodied the same as each layout length H of the plurality of unit input/output circuits 41-1 to 41-n. Here, ‘the same’ means, of course, a substantial equality within an acceptable error range. Accordingly, a length of a voltage detection circuit may be the same as a length of each of the input/output blocks.

FIG. 2B schematically illustrates a package including the semiconductor device 30 illustrated in FIG. 2A. Referring to FIGS. 1A, 2A, and 2B, when each semiconductor device 20, 30 or 40 is embodied in a chip type, each of the semiconductor devices 20, 30 and 40 may be packaged in a package 30a.

For example, the package 30a may include the semiconductor device 30 (embodied as a SoC or as an integrated circuit style) and a plurality of electrical connection means (e.g., a plurality of bonding wires 47 and a plurality of input/output pins 48). Each input/output pad of the semiconductor device 30 is connected to the plurality of input/output pins 48 through the plurality of bonding wires 47.

The package 30a may be embodied in a Package On Package (PoP), a Ball Grid Array (BGA), a Chip Scale Package (CSP), a Plastic Leaded Chip Carrier (PLCC), a Plastic Dual In-Line Package (PDIP), a Die in Waffle Pack, a Chip On Board (COB), a CERamic Dual In-Line Package (CERDIP), a Plastic Metric Quad Flat Pack (MQFP), a Thin Quad FlatPack (TQFP), a Small Outline Integrated Circuit (SOIC), a Shrink Small Outline Package (SSOP), a Thin Small Outline Package (TSOP), a System In Package (SIP), a Multi-Chip Package (MCP), a Wafer-level Fabricated Package (WFP), or a Wafer-level Processed Stack Package (WSP).

FIG. 3 is a block diagram of the unit input/output block 41 illustrated in FIG. 2A.

Referring to FIGS. 2A and 3, the input/output block 41 includes a plurality of unit input/output circuits 41-1 to 41-n and a voltage detection circuit 45. Each of unit input/output circuits 41-1 to 41-n includes a respective one of pad control circuits 60-1 to 60-n and a respective one of input/output pads 62-1 to 62-n.

After both of the first voltage VDD and the second voltage DVDD are powered up, each of the pad control circuits 60-1 to 60-n may control a usage of a respective one of input/output pads 62-1 to 62-n in response to at least an input/output control signal output from the core logic 43.

During a power up operation or a power down operation responsive to power distribution from external Power Management Unit (PMU) 50 and/or internal Power Management Unit (iPMU) 133, the voltage detection circuit 45 detects at least a voltage level of the first voltage VDD and a voltage level of the second voltage DVDD and generates a detection signal OUTA based on detection result. For example, the voltage detection circuit 45 may generate the detection signal OUTA having a low level when either of the first voltage VDD and/or the second voltage DVDD are less than respective voltage detection levels as illustrated in FIGS. 13A and 13B. The voltage detection circuit 45 may generate the detection signal OUTA having a high level when both of the first voltage VDD and the second voltage DVDD are greater than the respective voltage detection levels.

Each of the pad control circuits 60-1 to 60-n may control a state of each input/output pad 62-1 to 62-n in response to the detection signal OUTA. For example, during a power up operation or a power down operation, each of the pad control circuits 60-1 to 60-n (also referred to as input/output circuits) may set a state of the respective input/output pads 62-1 to 62-n to high impedance Hi-Z state, a high voltage level, or a low voltage level according to some embodiments in response to an inactive or low-level detection signal OUTA. Responsive to a high level detection signal OUTA (when both first and second voltages VDD and DVDD exceed respective voltage detection levels), each of the pad control circuits 60-1 to 60-n may be configured to be set to a second state to allow data communication between core logic 43 and the respective input/output pad.

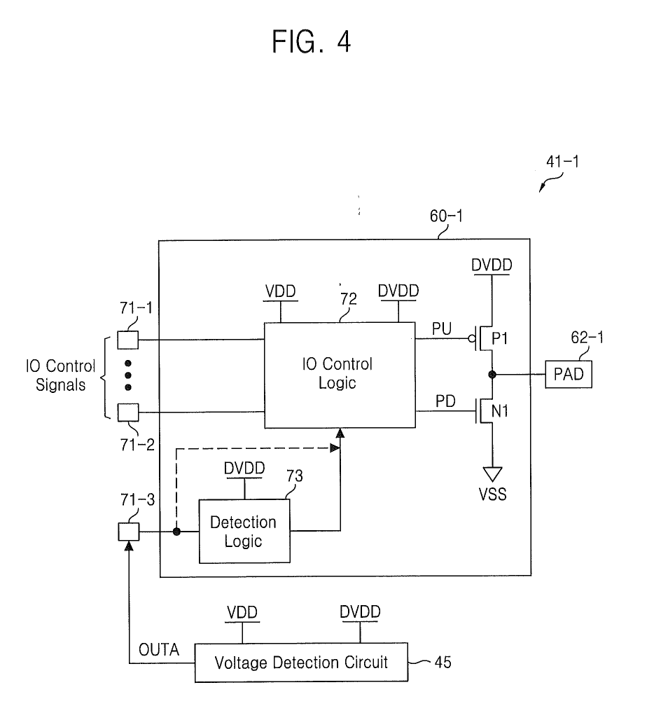

FIG. 4 is a block diagram illustrating an example embodiment of a unit input/output circuit 41-1 illustrated in FIG. 3. FIG. 4 illustrates an unit input/output circuit 41-1 including a pad control circuit 60-1, an input/output pad 62-1 and a plurality of control pins 71-1, . . . , 71-2 and 71-3, and a voltage detection circuit 45 for the purpose of explanation.

At least an input/output control signal generated by the core logic 43 after the first voltage VDD is completely powered up is supplied to the pad control circuit 60-1 through input/output control pins 71-1, . . . , 71-2. Accordingly, the pad control circuit 60-1 controls a usage of an input/output pad 62-1, i.e., whether to use the input/output pad 62-1 as an input pad or an output pad, in response to the at least an input/output control signal.

During a power up operation or a power down operation, the detection signal OUTA generated by the voltage detection circuit 45 is supplied to the pad control circuit 60-1 through an input/output pad state control pin 71-3. Accordingly, the pad control circuit 60-1 sets a state of the input/output pad 62-1 in response to the detection signal OUTA.

The pad control circuit 60-1 includes input/output control logic 72 configured to generate a plurality of control signals PU and PD in response to the detection signal OUTA and an input/output pad driver configured to set a state of the input/output pad 62-1 to high impedance in response to the plurality of control signals PU and PD.

The input/output pad driver includes a PMOS transistor P1 connected between a power line supplying the second voltage DVDD and the input/output pad 62-1 and an NMOS transistor N1 connected between the input/output pad 62-1 and a ground VSS.

For example, when the pad control signal 60-1 generates a first control signal PU having a high level and a second control signal PD having a low level in response to the detection signal OUTA having a low level during a power up operation, each MOS transistor P1 and N1 is turned off so that a state of the input/output pad 62-1 is high impedance.

However, when the pad control circuit 60-1 generates a first control signal PU having a low level and a second control signal PD having a low level in response to the detection signal OUTA having a high level, the second voltage DVDD may be supplied to the input/output pad 62-1 through the PMOS transistor P1. Stated in other words, PMOS transistor P1 may be turned on coupling second voltage DVDD to pad 621, and NMOS transistor N1 may be turned off decoupling ground voltage VSS from pad 62-1.

As described above, the pad control circuit 60-1 may control an operation of an input/output pad driver according to a level of the detection signal OUTA.

According to an example embodiment, the pad control circuit 60-1 may further include detection logic 73 configured to detect a level of the detection signal OUTA. Here, the detection logic 73 may detect occurrence of the detection signal OUTA and generate a signal. Accordingly, input control logic 72 may adjust each level of the plurality of control signals PU and PD according to the signal output from the detection logic 73.

As described above, when the input/output control logic 72 generates a first control signal PU having a high level and a second control signal PD having a low level, each MOS transistor P1 and N1 is turned off so that the input/output pad 62-1 is in a high impedance state.

According to an example embodiment, the input/output control logic 72 may control each level of the control signals PU and PD in response to the detection signal OUTA and in response to the IO control signals. In this case, the input/output pad driver may pull a voltage of the input/output pad 62-1 up to the second voltage DVDD or down to the ground VSS.

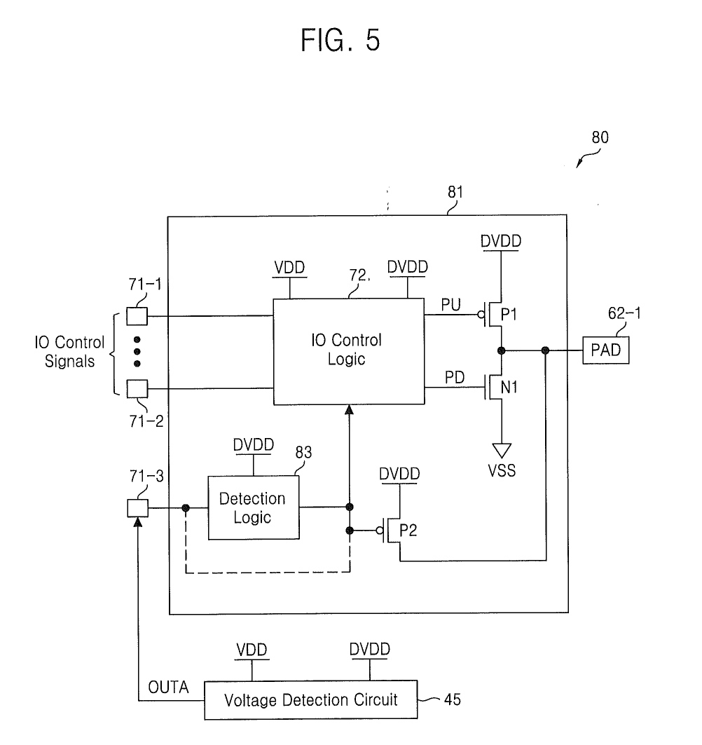

FIG. 5 is a block diagram illustrating another example embodiment of a unit input/output circuit 80 that may be used as a unit input/output circuit illustrated in FIG. 3. The unit input/output circuit 80 of FIG. 5 is another example embodiment of the unit input/output circuit 41-1 illustrated in FIG. 3. For convenience of explanation, FIG. 5 illustrates the unit input/output circuit 80 including a pad control circuit 81, input/output pad 62-1, a plurality of control pins 71-1, . . . , 71-2 and 71-3, and voltage detection circuit 45.

During power up and/or a power down operations, a detection signal OUTA generated by the voltage detection circuit 45 is supplied to a pad control circuit 81 through the input/output pad control pin 71-3. The pad control circuit 81 may perform a same function as the pad control circuit 60-1 illustrated in FIG. 3 to set a state of the input/output pad 62-1 in response to the detection signal OUTA and in response to IO control signals.

The pad control circuit 81 includes a pull up circuit P2 configured to supply the second voltage DVDD to the input/output pad 62-1 in response to the detection signal OUTA having a low level. When the pull up circuit P2 is embodied in a PMOS transistor, a state of the input/output pad 62-1 is pulled up to a high level, e.g., the second voltage DVDD.

According to an example embodiment, when the pad control circuit 81 outputs a first control signal PU having a high voltage level and a second control signal PD having a low level in response to the detection signal OUTA having a low level, each MOS transistor P1 and N1 is turned off. Accordingly, a state of the input/output pad 62-1 is pulled up to a high voltage level, e.g., the second voltage DVDD, by the pull up circuit P2 even though transistors P1 and N1 are both turned off. According to still other embodiments, pad control circuit 81 may be configured to be set to a high impedance state followed by the high voltage level (e.g., DVDD) in response to the detection signal OUTA having the low voltage level.

According to an example embodiment, the pad control circuit 81 may further include detection logic 83 configured to detect the detection signal OUTA. The detection logic 83 may generate a signal by detecting a level of the detection signal OUTA. In this case, the pull up circuit P2 may pull up a state of the input/output pad 62-1 to a high level, e.g., the second voltage DVDD, in response to a signal having a low level output from the detection logic 83. In addition, the input/output control logic 72 may generate a plurality of control signals PU and PD controlling an operation of an input/output pad driver according to a signal output from the detection logic 83.

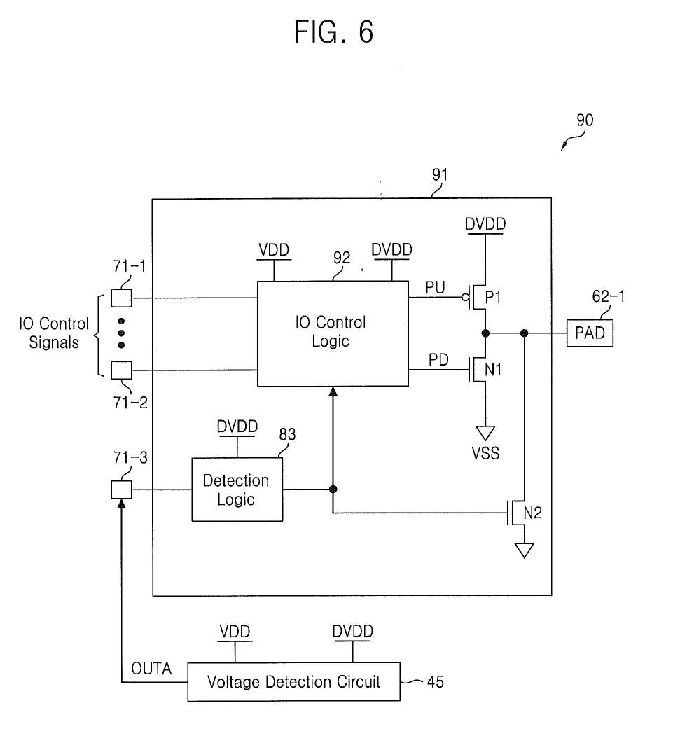

FIG. 6 is a block diagram illustrating still another example embodiment of a unit input/output circuit 90 that may be used as a unit input/output circuit of FIG. 3. The unit input/output circuit 90 illustrated in FIG. 6 is still another example embodiment of the unit input/output circuit 41-1 illustrated in FIG. 3. For convenience of explanation, FIG. 6 illustrates the unit input/output circuit 90 including a pad control circuit 91, input/output pad 62-1, control pins 71-1, . . . , 71-2 and 71-3, and voltage detection circuit 45.

During power up and/or a power down operations, a detection signal OUTA generated by the voltage detection circuit 45 is supplied to the pad control circuit 81 through an input/output pad state control pin 71-3. The pad control circuit 91 may perform the same function as the pad control circuit 60-1 of FIG. 3 to set a state of the input/output pad 62-1 in response to the detection signal OUTA and in response to IO control signals.

The detection logic 83 included in the pad control circuit 91 may supply a high level, e.g., the second voltage, to the pull down circuit N2 in response to the detection signal OUTA having a low level. The pull down circuit N2 embodied as an NMOS transistor pulls the input/output pad 62-1 down to a ground voltage VSS. Accordingly, a state of the input/output pad 62-1 is pulled down to a low level, e.g., a ground.

Input/output control logic 92 generates a plurality of control signals PU and PD to control an operation of the input/output pad driver according to a signal having a high level output from the detection logic 83. A state of the input/output pad 62-1 may be pulled down to a low level, e.g., ground voltage VSS, by the pull down circuit N2 even though transistors P1 and N1 are turned off. According to still other embodiments, pad control circuit 91 may be configured to be set to a high impedance state followed by a low voltage level (e.g., VSS) in response to the detection signal OUTA having the low voltage level.

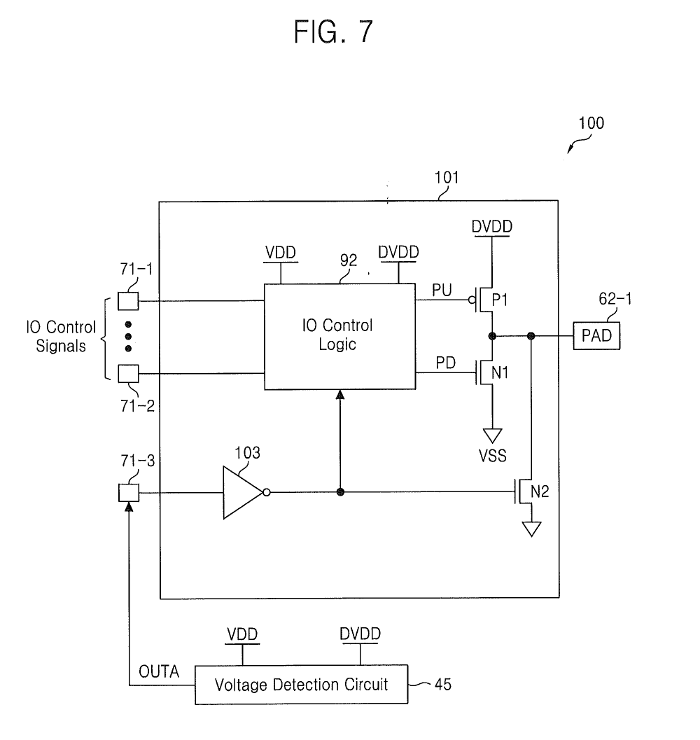

FIG. 7 is a block diagram illustrating still another example embodiment of a unit input/output circuit 100 that may be used as a unit input/output circuit of FIG. 3. The unit input/output circuit 100 illustrated in FIG. 7 is still another example embodiment of the unit input/output circuit 41-1 of FIG. 3. For convenience of explanation, FIG. 7 illustrates the unit input/output circuit 100 including a pad control circuit 101, input/output pad 62-1, control pins 71-1, . . . 71-2, and 71-3, and voltage detection circuit 45.

Except for inverter 103, a configuration of the pad control circuit 101 of FIG. 7 is substantially the same as the pad control circuit 91 of FIG. 6. The inverter 103 inverts a detection signals OUTA having a low level output from the voltage detection circuit 45. Accordingly, the pull down circuit N2 pulls a state of the input/output pad 62-1 down to a low level (e.g., ground voltage VSS) in response to a high voltage level output signal of the inverter 103.

As described above, a state of the input/output pad 62-1 may be pulled down to a low level, .e.g., a ground voltage VSS, by the pull down circuit N2 embodied as an NMOS transistor even though transistors P1 and N1 are turned off. According to still other embodiments, pad control circuit 101 may be configured to be set to a high impedance state followed by a low voltage level (e.g., VSS) in response to the detection signal OUTA having the low voltage level.

In each of FIGS. 4-7, a pad control circuit may be configured to allow data communication (responsive to a high voltage level of detection signal OUTA when voltages VDD and DVDD both exceed respective detection thresholds) by coupling the respective input/output pad to one of ground voltage VSS (through transistor N1) or voltage DVDD (through transistor P1) responsive to IO control signals from core logic. During data communication (when VDD and DVDD both exceed respective detection thresholds), pad control circuits 60-1 to 60-n of FIG. 3 may be configured to simultaneously transmit different logic values from different respective pads.

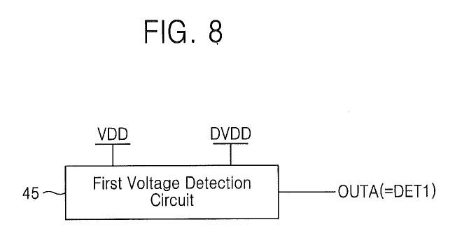

FIG. 8 is an example embodiment of the voltage detection circuit 45 illustrated in FIG. 2A. The voltage detection circuit 45 detects a first voltage VDD powering up or powering down using a hysteresis circuit to provide hysteresis, e.g., a Schmidt trigger or a Schmidt trigger inverter, and generates a detection signal OUTA=DET1.

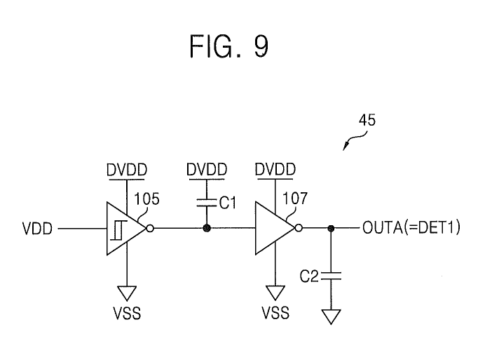

FIG. 9 is a circuit diagram illustrating an example embodiment of the voltage detection circuit 45 illustrated in FIG. 8. Referring to FIG. 9, the voltage detection circuit 45 includes a Schmidt trigger inverter 105 receiving a first voltage VDD as an input voltage and an inverter 107 generating a detection signal OUTA=DET1 by inverting an output signal of the Schmidt trigger inverter 105.

According to a difference between an upper threshold and a lower threshold of the Schmidt trigger inverter 105, the Schmidt trigger inverter 105 detects a level of the first voltage VDD powering up using the upper threshold and a level of the first voltage VDD powering down using the lower threshold. The upper threshold and the lower threshold may be used as a voltage detection level, respectively.

The voltage detection circuit 45 may further include a first capacitor C1 connected to a power line supplying the second voltage DVDD and an output terminal of the Schmidt trigger inverter 105, and a second capacitor C2 connected between an output terminal of the inverter 107 and a ground VSS. Each capacitor C1 and/or C2 may perform a function of an initial state keeping capacitor.

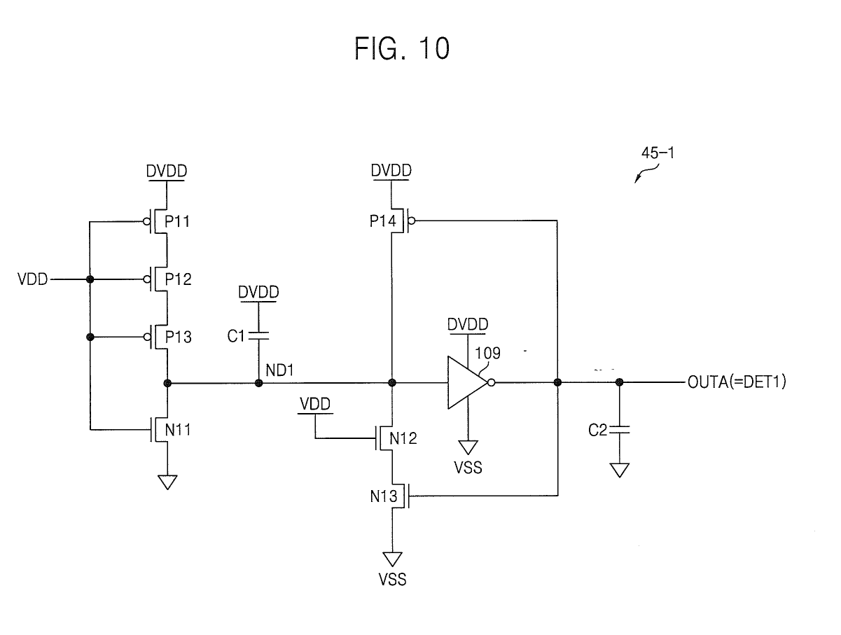

FIG. 10 is a circuit diagram illustrating another example embodiment of the voltage detection circuit illustrated in FIG. 8. Referring to FIG. 10, a voltage detection circuit 45-1, which uses hysteresis embodied as an example of the voltage detection circuit 45 illustrated in FIG. 2A or 3, includes at least PMOS transistors P11 to P13 connected in series between a power line supplying the second voltage DVDD and a node ND1, at least an NMOS transistor N11 connected in series between the node ND1 and a ground VSS, an inverter 109 configured to generate the detection signal OUTA=DET1 by inverting a signal of the node ND1, a pull up circuit P14 configured to supply the second voltage DVDD to the node ND1 in response to an output signal of the inverter 109, and a pull down circuit configured to pull the node ND1 down to the ground VSS in response to the first voltage VDD and an output signal of the inverter 109.

The first voltage VDD is supplied to a gate of at least PMOS transistors P11 to P13 and a gate of at least an NMOS transistor N11.

When a ratio, e.g., a first ratio of a channel length and a channel width of at least PMOS transistors P11 to P13 is the same and a ratio, e.g., a second ratio of a channel length and a channel width of the at least NMOS transistor N11 is the same, a state transition, i.e., a level transition, of the detection signal OUTA=DET1 may be determined according to a ratio between the first ratio and the second ratio.

The pull down circuit may include a first switch N12 and a second switch N13 connected in series between the node ND1 and the ground VSS. The first switch N12 is switched in response to the first voltage VDD and the second switch N13 is switched in response to an output signal of the inverter 109.

Here, the first switch N12 performs a function of blocking the node ND1 from being pulled to a low voltage level when the first voltage VDD is in a power off state and the second voltage DVDD is in a power on state.

The voltage detection circuit 45-1 may further include a first capacitor C1 connected between a power line supplying the second voltage DVDD and the node ND1, and a second capacitor C2 connected between an output terminal of the inverter 109 and the ground VSS. The first capacitor C1 may perform a function of keeping a voltage of the node ND1 at a high voltage level when the second voltage DVDD is ramping up prior to the first voltage VDD during a power up operation.

For example, if the voltage detection circuit 45-1 is designed to detect the first voltage VDD above 0.5V, e.g., a voltage detection level, as a high level according to a ratio between the first ratio and the second ratio, the node ND1 transits from a high level to a low level when the first voltage VDD increases above 0.5V during a power up operation. Accordingly, the inverter 109 generates a detection signal OUTA transiting from a low level to a high level.

That is, the voltage detection circuit 45-1 during a power up operation generates a detection signal OUTA having a low level until the first voltage VDD becomes 0.5V, so that the pad control circuit 60-1, 81, 91 or 101 may set a state of the input/output pad 62-1 to high impedance, a high voltage level (e.g., the second voltage DVDD), or a low voltage level (e.g., ground VSS) in response to a detection signal OUTA having a low level.

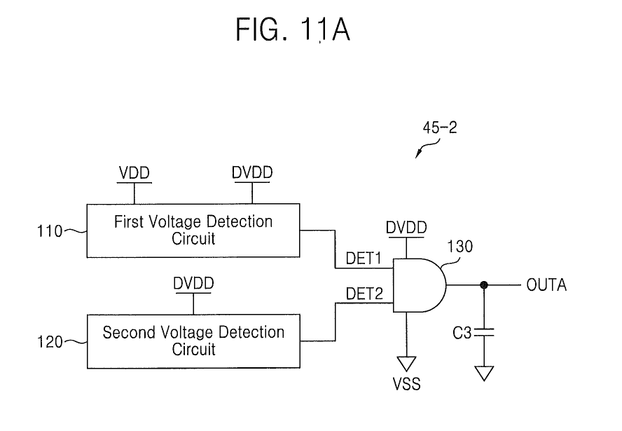

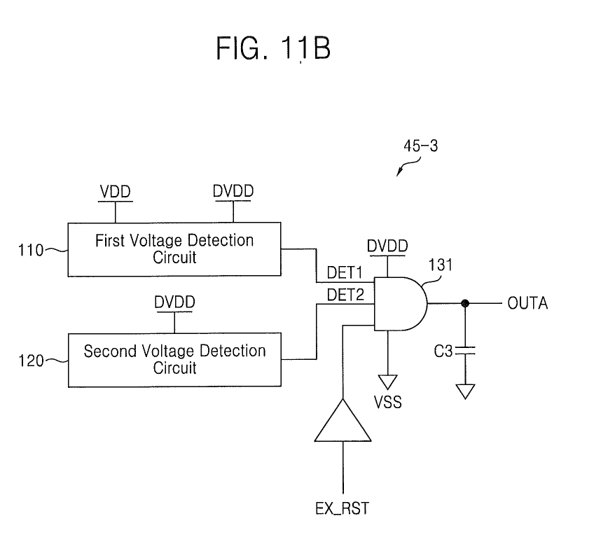

FIG. 11A is another example embodiment of the voltage detection circuit illustrated in FIG. 2A. The voltage detection circuit 45-2 (embodied as another example of the voltage detection circuit 45 of FIG. 2A) may include a first voltage detection circuit 110, a second voltage detection circuit 120, and a combination logic circuit (e.g., an AND gate 130).

The first voltage detection circuit 110 may be embodied as a voltage detection circuit 45 or 45-1 illustrated in FIGS. 9 and 10, respectively. That is, the first voltage detection circuit 110 may detect a voltage level of the first voltage VDD using a hysteresis circuit using a second voltage DVDD as an operation voltage and receiving the first voltage VDD as an input voltage, to generate a first detection signal DET1.

The second voltage detection circuit 120 may detect a voltage level of the second voltage DVDD using a threshold voltage of at least a diode-connected PMOS transistor receiving the second voltage DVDD as an input voltage to generate a second detection signal DET2.

The AND gate 130 performs an AND operation on the first detection signal DET1 and the second detection signal DET2 and generates a detection signal OUTA. The AND gate 130 may use the second voltage DVDD and a ground VSS as operation voltages. The capacitor C3 may be connected between an output terminal of the AND gate 130 and a ground voltage VSS to stabilize the detection signal OUTA.

As illustrated in FIGS. 13A and 13B, regardless of a power up operation sequence or a power down operation sequence of each voltage VDD and DVDD, when a level of the first voltage VDD ramping up or ramping down is lower than a voltage detection level of the first voltage detection circuit 110 or a level of the second voltage DVDD ramping up or ramping down is lower than a voltage detection level of the second voltage detection circuit 120, the voltage detection circuit 45-2 generates a detection signal OUTA having a low voltage level using the AND gate 130.

FIG. 11B is still another example embodiment of the voltage detection circuit illustrated in FIG. 2A. The voltage detection circuit 45-3 embodied as still another example of the voltage detection circuit 45 illustrated in FIG. 2A includes a first voltage detection circuit 110, a second voltage detection circuit 120, and AND gate 131.

The AND gate 131 generates a detection signal OUTA having a high voltage level or a low voltage level according to a level of a first detection signal DET1 generated by the first voltage detection circuit 110, a level of a second detection signal DET2 generated by the second voltage detection circuit 120, and a level of an external reset signal EX_RST input from outside. That is, when a level of any one of the plurality of signals DET1, DET2 and EX_RST is at a low voltage level, a detection signal OUTA having a low voltage level is generated. In contrast, when all of the signals DET1, DET2, and EX_RST are at a high voltage level, a detection signal OUTA having a high voltage level is generated.

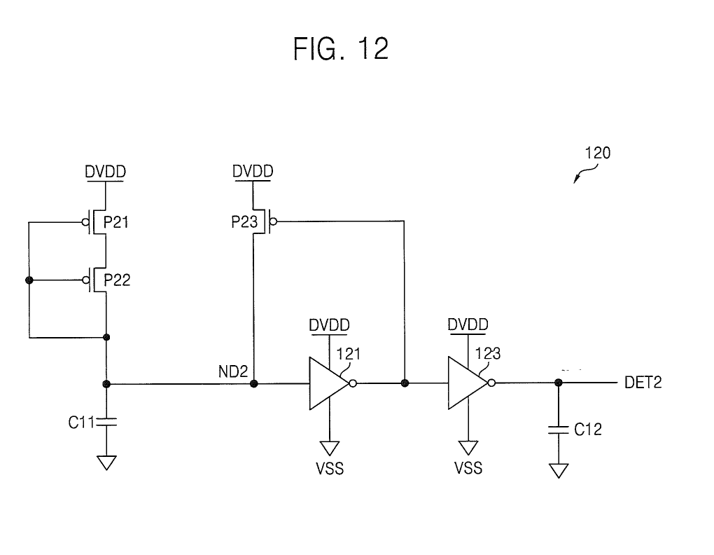

FIG. 12 is a circuit diagram of the second voltage detection circuit 120 illustrated in FIG. 11A or 11B. Referring to FIG. 12, the second voltage detection circuit 120 includes at least one diode-connected PMOS transistor string P21 and P22 connected in series between a power line supplying the second voltage DVDD and a node ND2, a first capacitor C11 connected between the node ND2 and a ground voltage VSS, a first inverter 121 configured to invert a signal of the node ND2, a pull up circuit P23 configured to supply the second voltage DVDD to the node ND2 according to an output signal of the first inverter 121, a second inverter 123 configured to generate a second detection signal DET2 by inverting an output signal of the first inverter 121, and a second capacitor C12 connected between an output terminal of the second inverter 123 and the ground voltage VSS.

During a power up operation, although the second voltage DVDD increases, a voltage of the node ND2 may be lower than the second voltage DVDD by as much as a threshold voltage of the diode-connected PMOS transistor string P21 and P22. Accordingly, the first inverter 121 may not perform an inverting operation until a voltage at the node ND2 increases to a predetermined level. That is, a voltage detection level (where an inverting operation) of the first inverter 121 is performed during a power up operation is determined according to the number of diodes included in the diode-connected PMOS transistor string P21 and P22. According to an example embodiment, at least one additional diode-connected PMOS transistor may be connected between the transistors P21 and P22.

For example, if the second voltage detection circuit 120 is designed to help a voltage of the node ND2 transit from a low level to a high level when the second voltage DVDD increases above 1.0V (i.e., a voltage detection level) the second voltage detection circuit 120 generates a second detection signal DET2 having a low level until the second voltage DVDD increases above 1.0V.

When the second voltage DVDD increases above 1.0V, an output signal of the first inverter 121 may transit from a high level to a low level. Accordingly, a pull up circuit P23 may supply the second voltage DVDD to the node ND2, so that an output signal of the first inverter 121 may sustain a low level.

FIG. 13A is an example embodiment of a waveform diagram of a first voltage and a second voltage as provided by an external PMU and/or an internal PMU and a detection signal as provided by VDC 45. Referring to some embodiments of FIGS. 1A to 10 and 13A, the voltage detection circuit 45 may detect the first voltage VDD only as follows.

After a second voltage DVDD ramps up at a time point T1 to a completely powered up state, and after a first voltage VDD performs a power up operation to begin ramping up at a time point T2, a Schmidt trigger inverter 105 illustrated in FIG. 9 generates a high voltage level and a voltage of the node ND1 illustrated in FIG. 10 maintains a high level by each PMOS transistor P11 to P13 until the first voltage VDD reaches 0.5V.

Accordingly, each of the inverter 107 of FIG. 9 and the inverter 109 of FIG. 10 generates a detection signal OUTA having a low level. Each pad control circuit 60-1, 81, 91 or 101 may set a state of an input/output pad 62-1 to high impedance (FIG. 4), a high voltage level (FIG. 5) or a low voltage level (FIG. 6 or 7) in response to a detection signal OUTA having a low voltage level.

When the voltage detection circuit 45 illustrated in FIG. 2A or 3 has the structure of voltage detection circuit 45-2 or 45-3 illustrated in FIG. 11A or 11B and a level of an external reset signal EX_RST is at a high voltage level, a second detection signal DET2 is at a high voltage level, so that a level of a detection signal OUTA generated by the AND gate 130 or 131 is determined according to a level of a first detection signal DET1.

That is, when the first voltage VDD performs a power up operation after the second voltage DVDD is powered up first, e.g., when a level of the second voltage DVDD is higher than a level of a voltage detection level of a second voltage detection circuit 120, a first voltage detection circuit 110 outputs a first detection signal DET1 having a low level until the first voltage VDD reaches 0.5V. So that, the AND gate 130 outputs a detection signal OUTA having a low voltage level. Accordingly, each pad control circuit 60-1, 81, 91 or 101 may set a state of the input/output pad 62-1 to high impedance (FIG. 4), a high voltage level (FIG. 5), or a low voltage level (FIG. 6 or 7) in response to a detection signal OUTA having a low level.

However, when the first voltage VDD increases above 0.5V, the detection signal OUTA has a high voltage level, so that each pad control circuit 60-1, 81, 91 or 101 may transmit data output from the core logic 43 to a bus 11 through the input/output pad 62-1 or receive data transmitted from the bus 11 and transmit it to the core logic 43 according to at least an input/output control signal output from the core logic 43.

When the first voltage VDD performs a power down operation or a ramping down at a time point T3 while the second voltage DVDD sustains a powered up state, the voltage detection circuit 45, 45-1 or 45-2 outputs a detection signal OUTA having a high voltage level until the first voltage VDD reaches a reference voltage, e.g., a lower threshold of hysteresis, lower than 0.5V, e.g., an upper threshold of hysteresis. A reason why the reference voltage is lower than 0.5V is because of hysteresis of the voltage detection circuit 45 or 45-1.

However, when the first voltage VDD becomes lower than the reference voltage, the Schmidt trigger inverter 105 illustrated in FIG. 9 transits from a low voltage level to a high voltage level and a voltage of the node ND1 of FIG. 10 transits to a high voltage level by PMOS transistors P11 to P13.

Accordingly, each voltage detection circuit 45 or 45-1 generates a detection signal OUTA having a low level. Accordingly, each pad control circuit 60-1, 81, 91 or 101 may set a state of the input/output pad 62-1 to high impedance (FIG. 4), a high voltage level (FIG. 5) or a low voltage level (FIG. 6 or 7) in response to the detection signal OUTA having a low voltage level.

Similarly, a voltage detection circuit 45-2 illustrated in FIG. 11A generates a detection signal OUTA having a low voltage level.

FIG. 13B is another example embodiment of a waveform diagram of a first voltage VDD and a second voltage DVDD as provided by an external PMU and/or an internal PMU and a detection signal OUTA as provided by VDC 45.

Referring to FIGS. 1A to 12 and 13B, when the second voltage DVDD performs a power up operation to begin ramping up at a time point T12 after the first voltage VDD has ramped up beginning at a time point T11, each voltage detection circuit 45, 45-1 or 45-2 outputs a detection signal OUTA having a low level until the second voltage DVDD reaches 1.0V, e.g., a voltage detection level, so that each pad control circuit 60-1, 81, 91 or 101 may set a state of the input/output pad 62-1 to high impedance (FIG. 4), a high voltage level (FIG. 5), or a low voltage level (FIG. 6 or 7) in response to the detection signal OUTA having a low voltage level.

While the second voltage DVDD maintains above 1.0V, each voltage detection circuit 45, 45-1 or 45-2 generates a detection signal OUTA having a high voltage level. Accordingly, each pad control circuit 60-1, 81, 91 or 101 may transmit data output from the core logic 43 to the bus 11 though the input/output pad 62-1 or receive data transmitted from the bus 11 and transmit it to the core logic 43 according to at least an input/output control signal output from the core logic 43.

When the second voltage DVDD performs a power down operation while the first voltage VDD sustains a powered up state, each voltage detection circuit 45, 45-1 or 45-2 outputs a detection signal OUTA having a low voltage level when the second voltage DVDD falls below 1.0V. Accordingly, each pad control circuit 60-1, 81, 91 or 101 may set a state of the input/output pad 62-1 to high impedance (FIG. 4), a high voltage level (FIG. 5) or a low voltage level (FIG. 6 or 7) in response to the detection signal OUTA having a low voltage level.

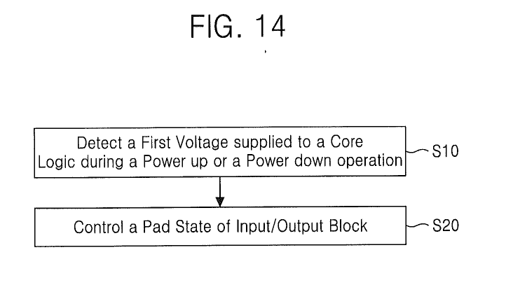

FIG. 14 is a flowchart illustrating operations of the voltage detection circuit illustrated in FIG. 2A.

Referring to FIGS. 1A to 14, during a power up operation or a power down operation, the voltage detection circuit 45 or 45-1 embodied in an input/output block 41 may detect a first voltage VDD supplied to the core logic 43 according to a voltage detection level and may generate a detection signal OUTA (S10). When the first voltage VDD is lower than a predetermined voltage, the voltage detection circuit 45 or 45-1 may generate a detection signal OUTA having a low level.

Each pad control circuit 60-1, 81, 91 or 101 may set a state of the input/output pad 62-1 to high impedance (FIG. 4), a high voltage level (FIG. 5) or a low voltage level (FIG. 6 or 7) in response to the detection signal OUTA having a low level (S20).

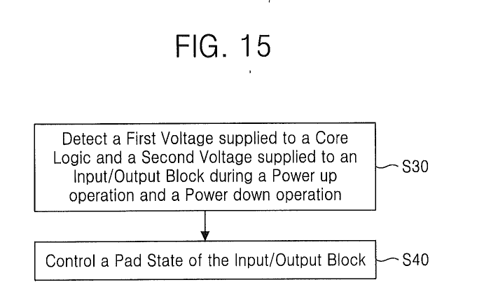

FIG. 15 is another flowchart illustrating operations of the voltage detection circuit illustrated in FIG. 2A.

Referring to FIGS. 1A to 13B and 15, the voltage detection circuit 45-2 embodied in the input/output block 41 during a power up operation or a power down operation may detect each of the first voltage VDD and the second voltage DVDD supplied to the core logic 43 according to each voltage detection level and may generate a detection signal OUTA (S30). When the first voltage VDD is lower than a predetermined voltage, e.g., 0.5V or a reference voltage, and/or the second voltage DVDD is lower than a predetermined voltage, e.g., 1.0V, the voltage detection circuit 45-2 may generate a detection signal OUTA having a low voltage level.

Each pad control circuit 60-1, 81, 91 or 101 may set a state of the input/output pad 62-1 to high impedance (FIG. 4), a high voltage level (FIG. 5) or a low voltage level (FIG. 6 or 7) in response to the detection signal OUTA having a low voltage level (S40).

That is, as explained referring to FIGS. 1A to 15, when a semiconductor device 30 is in a power off state or at least one of the first voltage VDD and the second voltage DVDD is lower than a predetermined voltage, e.g., 0.5V for VDD and 1.0V for DVDD during a power up operation or a power down operation, the voltage detection circuit 45, 45-1 or 45-2 may generate a detection signal OUTA having a low level.

Each pad control circuit 60-1, 81, 91 or 101 may set a state of the input/output pad 62-1 to high impedance (FIG. 4), a high voltage level (FIG. 5) or a low voltage level (FIG. 6 or 7) in response to the detection signal OUTA having a low voltage level.

That is, embodiments according to some inventive concepts may set each state of a plurality of pads embodied in the input/output block to a requested state, e.g., high impedance, a high voltage level or a low voltage level, regardless of an order of a power sequence of the first and second voltage VDD and DVDD supplied to the core logic 43, e.g., during power up and/or power down operations.

Accordingly, a power up operation or a power down operation of the semiconductor device 30 may not significantly affect a signal where a plurality of semiconductor devices 20 and 40 communicate through the bus 11 to which semiconductor device 30 is coupled.

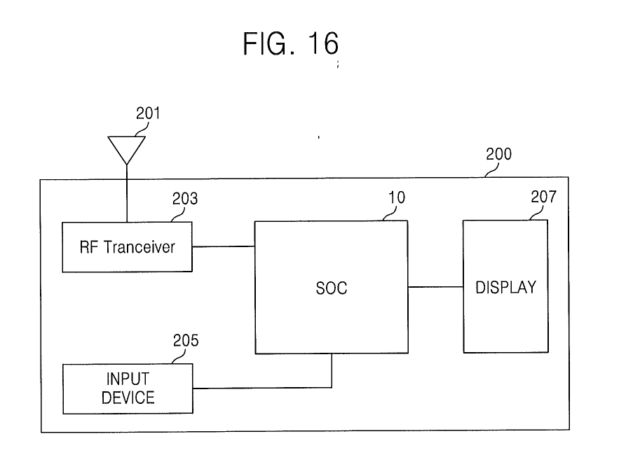

FIG. 16 is an embodiment example of a device 200 including the system 10 illustrated in FIG. 1A. Referring to FIG. 16, the device 200 includes a system 10 including a plurality of SoC devices (e.g., devices 20, 30, and 40), a radio transceiver 203, an input device 205, and a display 207.

The radio transceiver 203 may transmit and/or receive a radio signal through an antenna ANT. For example, the radio transceiver 203 may translate a radio signal received through the antenna ANT into a signal which may be processed by the system 10. Accordingly, the system 10 may process a signal output from the radio transceiver 203 and provide a processed signal to the display 207. In addition, the radio transceiver 203 may translate a signal generated by the system 10 into a radio signal and transmit a translated radio signal to an external device through the antenna ANT.

The input device 205 may be embodied as a pointing device (such as a touch pad, a computer mouse, a keypad or a keyboard) which may receive input of a control signal used to control an operation of the system 10 or data to be processed by the system 10. Devices according to example embodiments of present inventive concepts and operation methods thereof may detect at least one of a voltage supplied to a core logic and a voltage supplied to an input/output block during a power up operation and/or a power down operation and set each state of a plurality of input/output pads integrated in the input/output block to high impedance according to a detection result.

The above-disclosed subject matter is to be considered illustrative and not restrictive, and the appended claims are intended to cover all such modifications, enhancements, and other embodiments, which fall within the true spirit and scope of present inventive concepts. Thus, to the maximum extent allowed by law, the scope of present inventive concepts is to be determined by the broadest permissible interpretation of the following claims and their equivalents, and shall not be restricted or limited by the foregoing detailed description.

1. A System on Chip (SoC) comprising:
a logic circuit;
a plurality of input/output pads;
a plurality of input/output circuits electrically coupled between the logic circuit and respective ones of the plurality of input/output pads; and
a voltage detection circuit coupled to the plurality of input/output circuits, wherein the voltage detection circuit is configured to detect first and second power supply voltages at the plurality of input/output circuits wherein the first and second power supply voltages have different on-state voltage levels.

2. The SoC of claim 1,
wherein the plurality of input/output circuits are configured to be set to a first state responsive to the voltage detection circuit detecting at least one of the first power supply voltage at a level less than a first threshold and/or the second power supply voltage at a level less than a second threshold, and
wherein the plurality of input/output circuits are configured to be set to a second state to allow data communication between the logic circuit and the respective input/output pads responsive to the voltage detector detecting the first power supply voltage at a level greater than the first threshold and detecting the second power supply voltage at a level greater than the second threshold.

3. The SoC of claim 2 wherein the plurality of input/output circuits being configured to be set to the first state comprises the plurality of input/output circuits being configured to be set to a high impedance output state.

4. The SoC of claim 2 wherein the plurality of input/output circuits being configured to be set to the first state comprises the plurality of input/output circuits being configured to be set to a high impedance state followed by a same low voltage output level.

5. The SoC of claim 2 wherein the plurality of input/output circuits being configured to be set to the first state comprises the plurality of input/output circuits being configured to be set to a high impedance state followed by a same high voltage output level.

6. The SoC of claim 2 wherein the plurality of input/output circuits are configured to allow data communication by simultaneously transmitting a high logic value from a first of the input/output circuits and a low logic value from a second of the input/output circuits.

7. The SoC of claim 6 wherein the second power supply voltage is greater than the first power supply voltage, wherein the second threshold is greater than the first threshold, wherein transmitting the high logic value comprises coupling the second power supply voltage to the respective first input/output pad through the first input/output circuit, and wherein transmitting the low logic value comprises coupling a ground voltage to the respective second input/output pad through the second input/output circuit.

8. The SoC of claim 2 wherein each of the plurality of input/output circuits comprises a pull up transistor coupled between the respective input/output pad and the second power supply voltage, and a pull down transistor coupled between the respective input/output pad and a ground voltage, wherein setting the plurality of input/output circuits to the first state comprises turning off the pull up and pull down transistors for the plurality of input/output circuits, and wherein allowing communication comprises for at least one of the input/output circuits turning on one of the pull up and pull down transistors while turning off the other of the pull up and pull down transistors.

9. The SoC of claim 8 wherein setting the plurality of input/output circuits to the first state further comprises for each of the input/output circuits coupling the respective input/output pad to the second power supply voltage.

10. The SoC of claim 8 wherein setting the plurality of input/output circuits to the first state further comprises for each of the input/output circuits coupling the respective input/output pad to a ground voltage.

11. The SoC of claim 1 further comprising:
a semiconductor integrated circuit substrate, wherein the logic circuit, the plurality of input/output circuits, the input/output pads, and the voltage detection circuit are integrated in/on the semiconductor integrated circuit substrate, and wherein the first and second power supply voltages are received from outside the semiconductor integrated circuit substrate.

12. The SoC of claim 2 wherein the plurality of input/output pads comprises a first plurality of input/output pads, wherein the plurality of input/output circuits comprises a first plurality of input/output circuits, and wherein the voltage detection circuit comprises a first voltage detection circuit, the electronic device SoC further comprising:
an internal power management circuit configured to receive the first and second power supply voltages from outside the SoC and to control distribution of the first and second power supply voltages across the SoC;
a second plurality of input/output pads;
a second plurality of input/output circuits electrically coupled between the logic circuit and respective ones of the second plurality of input/output pads;
a second voltage detection circuit coupled to the plurality of input/output circuits, wherein the second voltage detection circuit is configured to detect the first and second power supply voltages at the second plurality of input/output circuits;
wherein the second plurality of input/output circuits are configured to be set to the first state responsive to the second voltage detection circuit detecting at least one of the first power supply voltage at a level less than a first threshold and/or the second power supply voltage at a level less than a second threshold at the second plurality of input/output circuits, and
wherein the second plurality of input/output circuits are configured to be set to the second state to allow data communication between the logic circuit and respective ones of the plurality of input/output pads responsive to the second voltage detection circuit detecting the first power supply voltage at a level greater than the first threshold and detecting the second power supply voltage at a level greater than the second threshold at the second plurality of input/output circuits.

13. The SoC of claim 12 wherein the internal power management circuit is configured to provide the first and second power supply voltages to the first plurality of input/output circuits while blocking the first and second power supply voltages from the second plurality of input/output circuits during a first time interval, and to provide the first and second power supply voltages to both of the first and second pluralities of input/output circuits during a second time interval.

14. The SoC of claim 1,
wherein the plurality of input/output circuits are configured to be set to a first state responsive to the voltage detection circuit detecting at least one of the first power supply voltage at a level less than a first threshold and/or the second power supply voltage at a level less than a second threshold and/or an external reset signal, and
wherein the plurality of input/output circuits are configured to allow data communication between the logic circuit and the respective input/output pads responsive to the voltage detector detecting the first power supply voltage at a level greater than the first threshold and detecting the second power supply voltage at a level greater than the second threshold and detecting an absence of the external reset signal.

15. The SoC of claim 1 wherein the voltage detection circuit comprises,
a first voltage detection circuit configured to generate a first enable signal responsive to the first power supply voltage being greater than a first threshold and responsive to the second power supply voltage being greater than a second threshold, and to generate a first disable signal responsive to the first power supply voltage being less than the first threshold and/or the second power supply voltage being less than the second threshold, and
a second voltage detection circuit configured to generate a second enable signal responsive to the second power supply voltage being greater than the second threshold without considering the first power supply voltage and to generate a second disable signal responsive to the second power supply voltage being less than the second threshold without considering the first power supply voltage,
wherein the plurality of input/output circuits are configured to be set to a first state responsive to the first voltage detection circuit generating the first disable signal and/or responsive to the second voltage detection circuit generating the second disable signal, and
wherein the plurality of input/output circuits are configured to be set to second state to allow data communication between the logic circuit and the respective input/output pads responsive to the first voltage detection circuit generating the first enable signal and responsive to the second voltage detection circuit generating the second enable signal.

16. The SoC of claim 1 wherein the voltage detection circuit comprises,
a first voltage detection circuit configured to generate a first enable signal responsive to the first power supply voltage being greater than a first threshold and responsive to the second power supply voltage being greater than a second threshold, and to generate a first disable signal responsive to the first power supply voltage being less than the first threshold and/or the second power supply voltage being less than the second threshold; and
a second voltage detection circuit configured to generate a second enable signal responsive to the second power supply voltage being greater than the second threshold without considering the first power supply voltage and to generate a second disable signal responsive to the second power supply voltage being less than the second threshold without considering the first power supply voltage;
wherein the plurality of input/output circuits are configured to be set to a first state responsive to the first voltage detection circuit generating the first disable signal and/or responsive to the second voltage detection circuit generating the second disable signal, and
wherein the plurality of input/output circuits are configured to be set to second state to allow data communication between the logic circuit and the respective input/output pads responsive to the first voltage detection circuit generating the first enable signal and responsive to the second voltage detection circuit generating the second enable signal.

17. The SoC of claim 16,
wherein the plurality of input/output circuits are configured to be set to a first state responsive to the first voltage detection circuit generating the first disable signal and/or responsive to the second voltage detection circuit generating the second disable signal and/or responsive to an external reset signal, and
wherein the plurality of input/output circuits are configured to be set to second state to allow data communication between the logic circuit and the respective input/output pads responsive to the first voltage detection circuit generating the first enable signal and responsive to the second voltage detection circuit generating the second enable signal and responsive to an absence of the external reset signal.

18. A System on Chip (SoC) comprising:
an internal power management circuit configured to receive first and second power supply voltages from outside the SoC and to control distribution of the first and second power supply voltages;
a logic circuit;
a first plurality of input/output pads;
a first plurality of input/output circuits electrically coupled between the logic circuit and respective ones of the first plurality of input/output pads; and
a first voltage detection circuit coupled to the first plurality of input/output circuits, wherein the first voltage detection circuit is configured to detect first and second power supply voltages from the internal power management circuit at the first plurality of input/output circuits wherein the first and second power supply voltages have different on-state voltage levels,
wherein the first plurality of input/output circuits are configured to be set to a first state responsive to the first voltage detection circuit detecting at least one of the first power supply voltage at a level less than a first threshold and/or the second power supply voltage at a level less than a second threshold at the first plurality of input/output circuits, and
wherein the first plurality of input/output circuits are configured to be set to a second state to allow data communication between the logic circuit and respective ones of the first plurality of input/output pads responsive to the first voltage detector detecting the first power supply voltage at a level greater than the first threshold and detecting the second power supply voltage at a level greater than the second threshold at the first plurality of input/output circuits;
a second plurality of input/output pads;
a second plurality of input/output circuits electrically coupled between the logic circuit and respective ones of the second plurality of input/output pads;
a second voltage detection circuit coupled to the second plurality of input/output circuits, wherein the second voltage detection circuit is configured to detect the first and second power supply voltages from the internal power management circuit at the second plurality of input/output circuits,
wherein the second plurality of input/output circuits are configured to be set to the first state responsive to the second voltage detection circuit detecting at least one of the first power supply voltage at a level less than a first threshold and/or the second power supply voltage at a level less than a second threshold at the second plurality of input/output circuits, and
wherein the second plurality of input/output circuits are configured to be set to the second state to allow data communication between the logic circuit and respective ones of the plurality of input/output pads responsive to the second voltage detection circuit detecting the first power supply voltage at a level greater than the first threshold and detecting the second power supply voltage at a level greater than the second threshold at the second plurality of input/output circuits.

19. The SoC of claim 18 wherein the internal power management circuit is configured to provide the first and second power supply voltages to the first plurality of input/output circuits while blocking the first and second power supply voltages from the second plurality of input/output circuits during a first time interval, and to provide the first and second power supply voltages to both of the first and second pluralities of input/output circuits during a second time interval.

20. A method of operating an electronic device including a plurality of input/output circuits electrically coupled between a logic circuit of the electronic device and respective input/output pads, the method comprising:
detecting first and second power supply voltages at the plurality of input/output circuits, wherein the first and second power supply voltages have different on-state voltage levels;
responsive to at least one of detecting the first power supply voltage at a level less than a first threshold and/or detecting the second power supply voltage at a level less than a second threshold, setting the plurality of input/output circuits to a first state; and
responsive to detecting the first power supply voltage at a level greater than the first threshold and detecting the second power supply voltage at a level greater than the second threshold, setting the plurality of input/output circuits to a second state to allow data communication through the plurality of input/output circuits between the logic circuit and the respective input/output pads.

21. The method of claim 20 wherein setting the plurality of input/output circuits to the first state comprises setting the plurality of input/output circuits to a high impedance output state.

22. The method of claim 20 wherein setting the plurality of input/output circuits to the first state comprises setting the plurality of input/output circuits to a high impedance state followed by a same low voltage output level.

23. The method of claim 20 wherein setting the plurality of input/output circuits to the first state comprises setting the plurality of input/output circuits to a high impedance state followed by a same high voltage output level.

24. The method of claim 20 wherein allowing data communication through the plurality of input/output circuits comprises simultaneously transmitting a high logic value from a first of the input/output circuits through a respective first of the input/output pads and a low logic value from a second of the input/output circuits through a respective second of the input/output pads.

25. The method of claim 24 wherein the second power supply voltage is greater than the first power supply voltage, wherein the second threshold is greater than the first threshold, wherein transmitting the high logic value comprises coupling the second power supply voltage to the respective first input/output pad, and wherein transmitting the low logic value comprise coupling a ground voltage to the respective second input/output pad.

26. The method of claim 20 wherein each of the plurality of input/output circuits comprises a pull up transistor coupled between the respective input/output pad and the second power supply voltage, and a pull down transistor coupled between the respective input/output pad and a ground voltage, wherein setting the plurality of input/output circuits to the first state comprises turning off the pull up and pull down transistors for the plurality of input/output circuits, and wherein allowing communication comprises for at least one of the input/output circuits turning on one of the pull up and pull down transistors while turning off the other of the pull up and pull down transistors.

27. The method of claim 26 wherein setting the plurality of input/output circuits to the first state further comprises for each of the input/output circuits coupling the respective input/output pad to the second power supply voltage.

28. The method of claim 26 wherein setting the plurality of input/output circuits to the first state further comprises for each of the input/output circuits coupling the respective input/output pad to a ground voltage.

29. The method of claim 20 wherein the logic circuit and the plurality of input/output circuits are integrated in/on a semiconductor integrated circuit substrate, and wherein the first and second power supply voltages are received from outside the semiconductor integrated circuit substrate.

30. An electronic system comprising:
a circuit board including a communications bus having a plurality of conductive bus lines;
a power management circuit on the circuit board, wherein the power management circuit is configured to provide first and second power supply voltages wherein the first and second power supply voltages have different on-state voltages; and
an electronic device on the circuit board, wherein the electronic device is configured to receive the first and second power supply voltages from the power management circuit, the electronic device comprising,
a logic circuit,
a plurality of input/output pads electrically coupled to respective ones of the conductive bus lines,
a plurality of input/output circuits electrically coupled between the logic circuit and respective ones of the input/output pads, and
a voltage detection circuit coupled to the plurality of input/output circuits, wherein the voltage detection circuit is configured to detect the first and second different power supply voltages at the plurality of input/output circuits.

31. The electronic system of claim 30,
wherein the plurality of input/output circuits are configured to be set to a first state responsive to the voltage detector detecting at least one of the first power supply voltage at a level less than a first threshold and/or the second power supply voltage at a level less than a second threshold, and
wherein the plurality of input/output circuits are configured to be set to a second state to allow data communication between the logic circuit and the respective bus lines of the communication bus responsive to the voltage detector detecting the first power supply voltage at a level greater than the first threshold and the second power supply voltage at a level greater than the second threshold.

32. The electronic system of claim 31 wherein the electronic device comprises a first electronic device, wherein the logic circuit comprises a first logic circuit, wherein the plurality of input/output pads comprises a first plurality of input/output pads, wherein the plurality of input/output circuits comprises a first plurality of input/output circuits, and wherein the voltage detection circuit comprises a first voltage detection circuit, the electronic system further comprising:
a second electronic device on the circuit board, wherein the second electronic device is configured to receive the first and second power supply voltages from the power management circuit, the second electronic device comprising,
a second logic circuit,
a second plurality of input/output pads electrically coupled to respective ones of the conductive bus lines,
a second plurality of input/output circuits electrically coupled between the second logic circuit and respective ones of the second plurality on input/output pads, and
a second voltage detection circuit coupled to the second plurality of input/output circuits, wherein the second voltage detection circuit is configured to detect the first and second different power supply voltages at the second plurality of input/output circuits,
wherein the second plurality of input/output circuits are configured to be set to the first state responsive to the second voltage detector detecting at least one of the first power supply voltage at a level less than the first threshold and/or the second power supply voltage at a level less than the second threshold, and
wherein the second plurality of input/output circuits are configured to be set to the second state to allow data communication between the second logic circuit and the respective bus lines of the communication bus responsive to the second voltage detector detecting the first power supply voltage at a level greater than the first threshold and the second power supply voltage at a level greater than the second threshold.

33. The electronic system of claim 32 further comprising:
a first semiconductor integrated circuit substrate wherein the first electronic device is integrated in/on the first semiconductor integrated circuit substrate; and
a second semiconductor integrated circuit substrate wherein the second electronic device is integrated in/on the second semiconductor integrated circuit substrate.

34. The electronic system of claim 32 wherein the power management circuit is configured to independently provide the first and second different power supply voltages to the first electronic device and to the second electronic device.

35. The electronic system of claim 32 wherein the power management circuit is configured to provide the first and second power supply voltages to the first electronic device while blocking the first and second power supply voltages from the second electronic device during a first time interval, and to provide the first and second power supply voltages to both of the first and second electronic devices during a second time interval.

36. The electronic system of claim 32 wherein the power management circuit comprises an external power management circuit, and wherein the first electronic device further comprises,
an internal power management circuit configured to receive the first and second power supply voltages from the external power management circuit and to control distribution of the first and second power supply voltages across the first electronic device,
a third plurality of input/output pads electrically coupled to respective ones of the conductive bus lines,
a third plurality of input/output circuits electrically coupled between the logic circuit and respective ones of the third plurality of input/output pads, and
a third voltage detection circuit coupled to the third plurality of input/output circuits, wherein the third voltage detection circuit is configured to detect the first and second different power supply voltages at the third plurality of input/output circuits,
wherein the third plurality of input/output circuits are configured to be set to the first state responsive to the third voltage detection circuit detecting at least one of the first power supply voltage at a level less than the first threshold and/or the second power supply voltage at a level less than the second threshold, and
wherein the third plurality of input/output circuits are configured to be set to the second state to allow data communication between the logic circuit and the respective input/output pads responsive to the third voltage detection circuit detecting the first power supply voltage at a level greater than the first threshold and detecting the second power supply voltage at a level greater than the second threshold.

37. The electronic system of claim 32, the electronic system further comprising:
a third electronic device on the circuit board, wherein the third electronic device is configured to receive the first and second power supply voltages from the power management circuit, the third electronic device comprising,
a third logic circuit,
a third plurality of input/output pads electrically coupled to respective ones of the conductive bus lines,
a third plurality of input/output circuits electrically coupled between the third logic circuit and respective ones of the third plurality on input/output pads, and
a third voltage detection circuit coupled to the third plurality of input/output circuits, wherein the third voltage detection circuit is configured to detect the first and second power supply voltages at the third plurality of input/output circuits,
wherein the third plurality of input/output circuits are configured to be set to the first state responsive to the third voltage detector detecting at least one of the first power supply voltage at a level less than the first threshold and/or the second power supply voltage at a level less than the second threshold, and
wherein the third plurality of input/output circuits are configured to be set to the second state to allow data communication between the third logic circuit and the respective bus lines of the communication bus responsive to the third voltage detector detecting the first power supply voltage at a level greater than the first threshold and the second power supply voltage at a level greater than the second threshold; and
wherein the power management circuit is configured to provide the first and second power supply voltages to the first and second electronic devices while blocking the first and second power supply voltages from the third electronic device during a first time interval, and to provide the first and second power supply voltages to the first, second, and third electronic devices during a second time interval.

38. A System on Chip comprising:
a logic circuit;
a plurality of input/output circuits electrically coupled between the logic circuit and a respective plurality of input/output pads; and
a voltage detection circuit coupled to the plurality of input/output circuits, wherein the voltage detection circuit is configured to detect first and second power supply voltages and wherein the first and second power supply voltages have different on-state voltage levels;
wherein the plurality of input/output circuits are configured to be set to a high impedance state responsive to the voltage detection circuit detecting at least one of the first power supply voltage at a level less than a first threshold and/or the second power supply voltage at a level less than a second threshold, and
wherein the plurality of input/output circuits are configured to allow data communication between the logic circuit and the respective input/output pads responsive to the voltage detector detecting the first power supply voltage at a level greater than the first threshold and detecting the second power supply voltage at a level greater than the second threshold.

39. The System on Chip of claim 38 wherein the plurality of input/output circuits are configured to allow data communication by simultaneously transmitting a high logic value from a first of the input/output circuits on and a low logic value from a second of the input/output circuits.

40. The System on Chip of claim 39 wherein the second power supply voltage is greater than the first power supply voltage, wherein the second threshold is greater than the first threshold, wherein transmitting the high logic value comprises coupling the second power supply voltage to a respective first of the plurality of input/output pads through the first input/output circuit, and wherein transmitting the low logic value comprise coupling a ground voltage to a respective second of the plurality of input/output pads through the second input/output circuit.

41. The System on Chip of claim 38 wherein each of the plurality of input/output circuits comprises a pull up transistor coupled between the respective input/output pad and the second power supply voltage, and a pull down transistor coupled between the respective input/output pad and a ground voltage, wherein setting the plurality of input/output circuits to the first state comprises turning off the pull up and pull down transistors for the plurality of input/output circuits, and wherein allowing communication comprises for at least one of the input/output circuits turning on one of the pull up and pull down transistors while turning off the other of the pull up and pull down transistors.

42. The System on Chip of claim 41 wherein setting the plurality of input/output circuits to the first state further comprises for each of the input/output circuits coupling the respective input/output pad to the second power supply voltage.

43. The System on Chip of claim 41 wherein setting the plurality of input/output circuits to the first state further comprises for each of the input/output circuits coupling the respective input/output pad to a ground voltage.

44. The System on Chip of claim 38 further comprising:
a semiconductor integrated circuit substrate, wherein the logic circuit, the plurality of input/output circuits, the plurality of input/output pads, and the voltage detection circuit are integrated in/on the semiconductor integrated circuit substrate, and wherein the first and second power supply voltages are received from outside the semiconductor integrated circuit substrate.

45. An electronic device comprising:
a logic circuit;
a plurality of input/output pads;
a plurality of input/output circuits electrically coupled between the logic circuit and respective ones of the plurality of input/output pads;
a voltage detection circuit coupled to the plurality of input/output circuits, wherein the voltage detection circuit is configured to detect first and second power supply voltages at the plurality of input/output circuits wherein the first and second power supply voltages have different on-state voltage levels,
wherein the plurality of input/output circuits are configured to be set to a first state responsive to the voltage detection circuit detecting at least one of the first power supply voltage at a level less than a first threshold and/or the second power supply voltage at a level less than a second threshold, and/or an external reset signal, and
wherein the plurality of input/output circuits are configured to allow data communication between the logic circuit and the respective input/output pads responsive to the voltage detector detecting the first power supply voltage at a level greater than the first threshold and detecting the second power supply voltage at a level greater than the second threshold and detecting an absence of the external reset signal.

46. An electronic device comprising:
a logic circuit;
a plurality of input/output pads;
a plurality of input/output circuits electrically coupled between the logic circuit and respective ones of the plurality of input/output pads wherein the plurality of input output circuits are configured to operate using first and second power supply voltages wherein an on-state voltage level of the first power supply voltage is less than an on-state voltage of the second power supply voltage;
a first voltage detection circuit configured to generate a first enable signal responsive to the first power supply voltage being greater than a first threshold and responsive to the second power supply voltage being greater than a second threshold, and to generate a first disable signal responsive to the first power supply voltage being less than the first threshold and/or the second power supply voltage being less than the second threshold; and
a second voltage detection circuit configured to generate a second enable signal responsive to the second power supply voltage being greater than the second threshold without considering the first power supply voltage and to generate a second disable signal responsive to the second power supply voltage being less than the second threshold without considering the first power supply voltage;
wherein the plurality of input/output circuits are configured to be set to a first state responsive to the first voltage detection circuit generating the first disable signal and/or responsive to the second voltage detection circuit generating the second disable signal, and
wherein the plurality of input/output circuits are configured to be set to second state to allow data communication between the logic circuit and the respective input/output pads responsive to the first voltage detection circuit generating the first enable signal and responsive to the second voltage detection circuit generating the second enable signal.

47. The electronic device of claim 46,
wherein the plurality of input/output circuits are configured to be set to a first state responsive to the first voltage detection circuit generating the first disable signal and/or responsive to the second voltage detection circuit generating the second disable signal and/or responsive to an external reset signal, and
wherein the plurality of input/output circuits are configured to be set to second state to allow data communication between the logic circuit and the respective input/output pads responsive to the first voltage detection circuit generating the first enable signal and responsive to the second voltage detection circuit generating the second enable signal and responsive to an absence of the external reset signal.
